(19) United States
(12) Patent Application Publication
(10) Pub. No.: US 2026/0322214 A1
(43) Pub. Date: Oct. 15, 2026

(54) COOLING SYSTEM FOR LOAD POINT-DEPENDENT COOLING OF A ROTOR OF AN ELECTRIC MACHINE

(71) Applicant: MAGNA Powertrain GmbH & Co KG, Lannach (AT)

(72) Inventors: Christoph Gsenger, Graz (AT); Wolfgang Schweiger, St.Stefan (AT)

(21) Appl. No.: 19/476,234

(22) PCT Filed: Apr. 16, 2024
(86) PCT No.: PCT/EP2024/060282

§ 371 Date: Oct. 17, 2025

(30) Foreign Application Priority Data
Apr. 20, 2023 (DE) 10 2023 203 657.6

(51) Int. Cl. H02K 9/19; H02K 7/116

(52) U.S. Cl. CPC H02K 9/19; H02K 7/116

(57) ABSTRACT

An electric drive includes a transmission unit and an electric machine with a cooling system having a coolant path extending at least partly into a rotor shaft, and at least one passive valve is arranged in the coolant path. The valve controls the flow rate of the coolant based on the temperature of the rotor. A central cavity at least partly passing through the rotor shaft constitutes one part of the coolant path, and at least one transverse bore connected to the central cavity and the outer circumference of the rotor shaft constitutes another part. The valve is a thermosensitive valve having a wax- or solid material-type expanding element that is installed into the rotor shaft in the region of the transverse bore either on the inlet side or on the outlet side.

### CROSS REFERENCE TO RELATED APPLICATIONS

This application is a National Stage of International Application No. PCT/EP2024/060282, filed Apr. 16, 2024, which claims priority to DE 10 2023 203 657.6, filed Apr. 20, 2023. The entire disclosures of each of the above applications are incorporated herein by reference.

### FIELD

The present invention relates to a cooling system for load point-dependent cooling of a rotor of an electric machine, wherein the cooling system has at least one coolant path which extends at least partially in a rotor of an electric machine and wherein at least one heat-sensitive valve is arranged in the coolant path which regulates the rate of flow of the coolant through the coolant path.

### BACKGROUND

This section provides information related to the present disclosure which is not necessarily prior art.

Electric machines serve to convert electrical energy into mechanical energy, and vice versa, and are often used as motors and/or generators in the automotive engineering sector.

Electric machines comprise a fixed stator and a rotatable rotor, wherein, in the most common type of electric machine, the rotor is mounted rotatably inside a stator with an annular form.

Because of the dielectric loss when they are operating, electric machines generate heat which, on the one hand, causes impairment of the efficiency of the electric machine and, on the other hand, negatively influences reliable operation of the electric machine over its lifetime. A cooling device which cools the parts of the electric machine to be cooled is therefore generally provided in drive assemblies with electric machines.

Conventional cooling systems for electric machines employ a circulating gaseous or liquid coolant. The coolant circulates, for example, in a housing of the electric machine or in a rotor shaft designed as a hollow shaft and on which the rotor of the electric machine is arranged. Because of its heat capacity, the coolant absorbs the heat and removes it. In order to increase the efficiency of an electric drive, it must be ensured that the individual losses such as friction or churning losses are minimized. Churning losses in the gearbox can occur from the engagement of teeth in the oil or also from oil being spun around in the rotor shaft. In order to reduce the losses in the rotor shaft, it must be ensured that oil is only fed into the rotor shaft when the shaft also has to be cooled. As a result, the hydrodynamic losses can be reduced, especially at low rotor temperatures.

DE 10 2016 004 931 A1 discloses an electric machine with a rotor shaft. The rotor shaft has an internal cavity into which a cooling lance is inserted. The interior of the hollow shaft is supplied with coolant via openings in the cooling lance depending on the pressure in the coolant line.

DE 10 2018 121 348 A1 discloses an electric motor with variable cooling of the stator but not the rotor. Speed-dependent valves are used here which open and close the flow of coolant to the stator depending on the speed.

The efficiency is increased by means of a temperature-sensitive valve at operating points with low electromagnetic losses and thus associated with a lower rotor temperature. At operating points with greater losses and a higher rotor temperature, the valve opens and thus enables efficient cooling of the rotor shaft.

DE 10 2021 205 656 A1 discloses load point-dependent cooling of a rotor of an electric machine. The cooling system has at least one coolant path which extends at least partially in a rotor of an electric machine. At least one passive valve which regulates the rate of flow of the coolant through the coolant path is arranged in the coolant path. A central cavity and a transverse bore connected at the outer circumference of the rotor shaft constitute one part of the coolant path. The passive valve can be arranged in the region of the central cavity and/or in the region of the transverse bore. It regulates the rate of flow of the coolant through the coolant path depending on a temperature of the rotor, a pressure in the coolant path, and/or a speed of the rotor.

US 2021/0 036 565 A1 discloses an electric generator which has a rotor cooling system. Cooling fluid is applied to different paths of the cooling system via a central inflow of the rotor. Some of the cooling ducts leading through the rotor here contain valves which are provided with a wax in order to regulate the inflows to the different cooling jets.

An object of the invention is to specify an improved cooling system for an electric machine, wherein a temperature-sensitive valve which is installed in the rotor shaft and thus cools it as required redirects the flow of oil at low rotor shaft temperatures.

### SUMMARY

This section provides a general summary of the disclosure, and is not a comprehensive disclosure of its full scope or all of its features.

The object is achieved by an electric drive with a gearbox unit and an electric machine with a cooling system for load point-dependent cooling of a rotor of the electric machine, wherein the cooling system has at least one coolant path which extends at least partially in the rotor and wherein at least one passive valve is arranged in the coolant path which regulates the rate of flow of the coolant through the coolant path depending on a temperature of the rotor, wherein a central cavity which passes at least partially through a rotor shaft of the rotor constitutes one part of the coolant path, and at least one transverse bore connected to the central cavity and to an outer circumference of the rotor shaft constitutes a further part of the coolant path, wherein the valve is a heat-sensitive valve with a wax or solid expansion element which is installed either on the input side or the output side in the rotor shaft in the region of the at least one transverse bore. The valve is a 3/2-way valve and is designed as a seat and sliding valve, wherein a tube seals the valve with respect to a housing of the electric machine or frees a radial coolant path.

In one embodiment, the valve is arranged in the region of a rotor toothing in the cavity of the rotor shaft.

In one embodiment, the valve has a restoring spring for restoring a valve piston which is displaceable in the valve body.

A reduction in the additional mechanical and hydraulic losses because of the cooling of a rotor of an electric machine can be obtained by means of a cooling system according to the present invention, as a result of which there is optimization in the areas of the efficiency and thermal availability of the electric machine.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a schematic illustration of a first implementation as a thermally actuatable 2/2-way sliding valve,

FIG. 2 shows a schematic illustration of a second implementation as a thermally actuatable 2/2-way seat valve,

FIG. 3 shows 3 an implementation of a thermally actuatable 2/2-way valve,

FIG. 4 shows an implementation of a thermally actuatable 2/2-way valve,

FIG. 5 shows a further implementation of a thermally actuatable 2/2-way valve,

FIG. 6 shows a further implementation of a thermally actuatable 2/2-way valve,

FIG. 7 shows an implementation of a thermally actuatable 3/2-way valve,

FIG. 8 shows an implementation of a thermally actuatable 3/2-way valve, and

FIG. 9 shows a view in section along A-A of FIG. 7.

### DETAILED DESCRIPTION

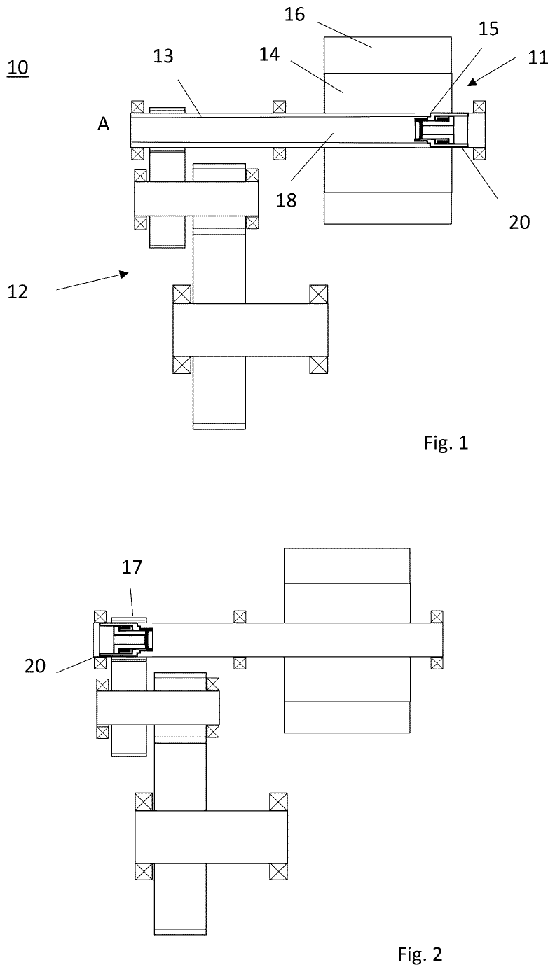

FIG. 1 shows a schematically illustrated electric drive 10. An electric machine 11 consists of a rotor with a rotor shaft 13 and a rotor lamination stack 14 which are arranged in a stator 16. The rotor shaft 13 is designed as partially hollow with an axially extending central cavity 18. The central cavity 18 constitutes one part of the coolant path 1 of the cooling system. The rotor shaft 13 furthermore has two radially extending transverse bores 15, connected to the central cavity 18 and to an outer circumference of the rotor shaft 13, which constitute a further part of the coolant path 1.

The direction specified as “axial” corresponds to a direction along or parallel to a central axis of rotation of the rotor. The direction specified as “radial” corresponds to a direction normal to the central axis of rotation of the rotor.

In all the alternative embodiments, a valve 20 which regulates the rate of flow of the coolant through the coolant path is arranged in the coolant path. The rotor shaft 13 drives a gearing assembly 12. In FIG. 1, a valve 15 is integrated at the side of the rotor shaft averted from the gearing mechanism 12, the input side E. The valve 15 controls a coolant flow which extends along the rotor shaft 13 in a cavity and runs in the direction of the stacks of rotor laminations 14 via openings 15 in the rotor shaft 13. An advantage of this implementation with an installation location on the input side is that the temperature of the rotor lamination stack can be measured directly and temperature measurement results of the rotor can be available for this implementation.

An electric drive 10 with almost the same structure is illustrated in FIG. 2, wherein in this exemplary embodiment the valve 20 is installed directly below a rotor toothing 17 on the output side A and decoupled from the rotor lamination stack temperature. The rotor toothing serves to link the rotor shaft 13 to the gearing assembly 12.

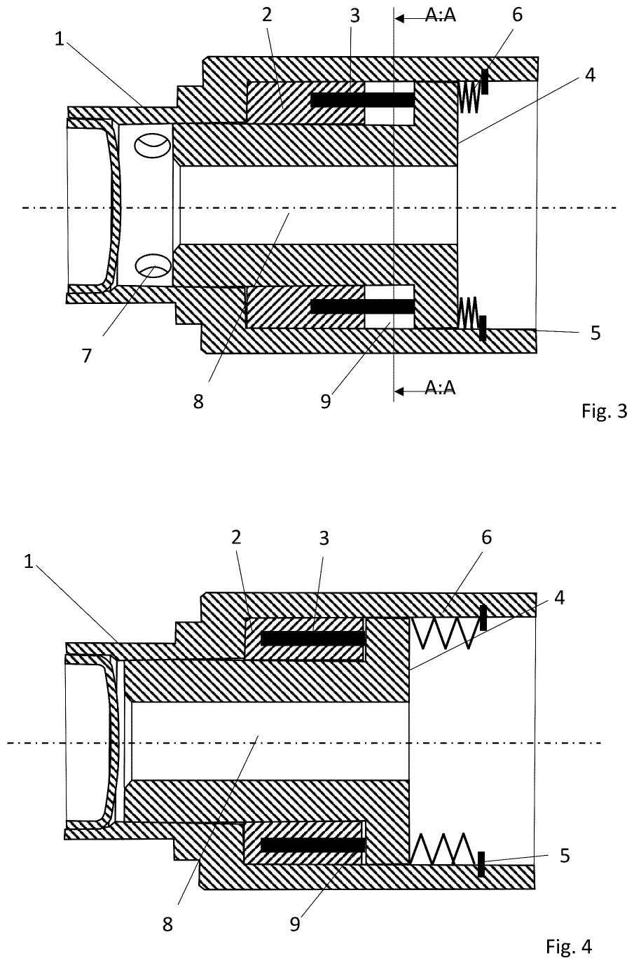

The temperature-sensitive valve 20 is illustrated in an illustration in section in each case in FIGS. 3 to 8. The valve 20 consists of a valve body 1, a valve piston 4 with an axial cavity 8, and a wax or solid expansion element 2 with high thermal expansion. The wax or solid expansion element 2 sits radially arranged between the valve body 1 and the valve piston 4.

FIG. 3 shows an opened state of the valve 20. In the opened state, bores 7 are exposed and coolant can flow through the cavity 8 from right to left and exit through the bores 7 and the corresponding transverse bores 15 in the rotor shaft 13.

A working piston 3 moves axially in and out of the wax or solid expansion element 2 and opens or closes the valve 20 by means of this wax or solid expansion element 2 depending on the temperature. The working piston 3 is thus pressed axially against the valve piston 4, and to be precise in the structural space 9 which is produced by the valve body 1 and the valve piston 4. If the wax or solid expansion element 2 can only absorb compressive forces, a restoring spring 6 is additionally installed which moves the valve 20 axially back into the starting position at a low temperature and thus closes the valve 20. The restoring spring 6 is mounted on a securing ring 5 and presses against the top side of the valve piston 4 which faces toward the valve input.

The closed state of the valve is illustrated in FIG. 4.

If a wax expansion element is used, as illustrated in FIGS. 3 and 4, it is necessary to install the restoring spring 6 in order to press the working piston 3 into the original position during the cooling. The working piston 3 is situated in a rest position and the restoring spring 6 displaces the valve piston 4 over the bores 7 such that there is only a flow axially via the cavity 8.

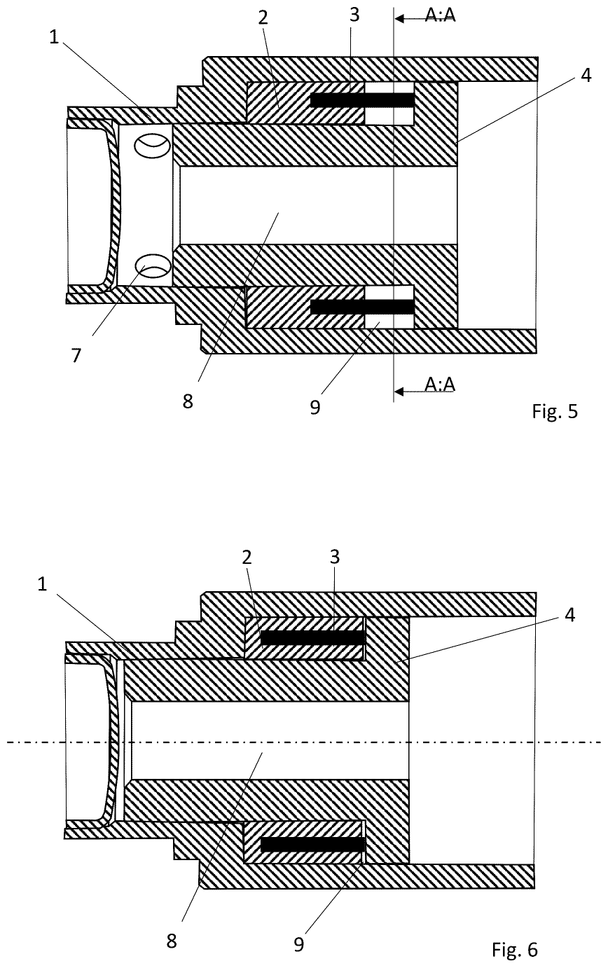

A valve with a solid element is illustrated in FIGS. 5 and 6. A solid element 2 expands when it is heated and thus moves the working piston 3 and thus causes the valve 20 to open. The coefficient of thermal expansion of the solid element 2 is chosen such that the valve opens above a defined temperature of the solid element. No restoring spring is installed in the valve 20 when a solid element is used which can absorb tensile and compressive forces.

The embodiments according to FIGS. 3 to 6 are designed as thermally actuatable 2/2-way seat valves. In the implementation as a seat valve, with a corresponding design of the valve seat, a good sealing effect of the bores 7 can be achieved. The implementation is furthermore largely resistant to contamination.

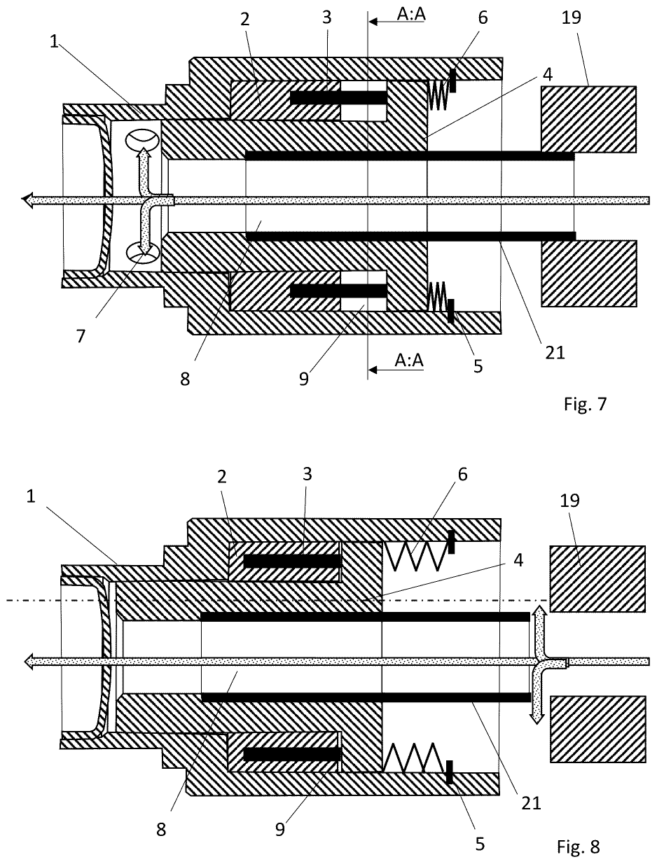

FIGS. 7 and 8 show a further implementation as a thermally actuatable 3/2-way valve in a combined implementation as a seat and sliding valve. In this embodiment, in addition to the components of FIGS. 3 and 4, an element in the form of a tube 21 is also employed. The opened position of the valve 20 is illustrated in FIG. 7. The tube 21 thus seals the inflow into the valve 20 with respect to the housing 19. The tube 21 is rigidly connected to the valve piston 4. In the closed position according to FIG. 8, the valve piston 4 has been displaced to the left via the restoring spring 6 and seals the bores 7. At the same time, the tube 21 is also displaced to the left and thus opens a gap between the housing 19 and the valve 20. A cooling flow upward and downward along the arrows indicated, i.e. radially from the coolant feed to the valve 20 outward with respect to the rotor shaft or the rotor laminations or also with respect to further components to be cooled, is thus opened.

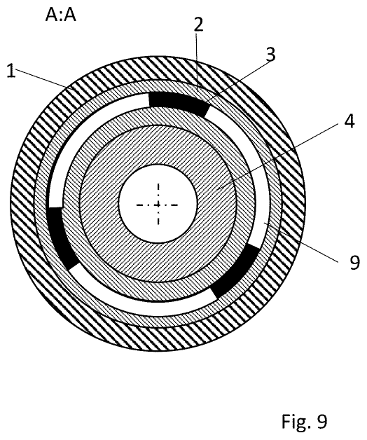

FIG. 9 shows a view in section of the axis A-A in FIGS. 3, 5, and 7. In this example, the working pistons 3 take the form of segments of a circle. They can, however, also have any possible cross section in the structural space 9 such as circular or oval, or can form a complete circle around the valve piston 4.

### LIST OF REFERENCE SIGNS

1 valve body
2 wax or solid expansion element
3 inner piston
4 valve piston
5 securing ring
6 restoring spring
7 bore
8 cavity
9 structural space
10 electric drive
11 electric machine
12 gearing assembly
13 rotor shaft
14 rotor lamination stacks
15 shaft opening
16 stator
17 rotor toothing
18 cavity
19 housing
20 valve
21 tube

1. An electric drive comprising:
a gearing unit and
an electric machine with a cooling system for load point-dependent cooling of a rotor of the electric machine,
at least one coolant path of the cooling system extending at least partially in a rotor shaft of the rotor,
at least one passive valve arranged in the coolant path that regulates the rate of flow of the coolant through the coolant path depending on a temperature of the rotor,
wherein a central cavity that passes at least partially through the rotor shaft of the rotor constitutes one part of the coolant path, and at least one transverse bore connected to the central cavity and to an outer circumference of the rotor shaft constitutes a further part of the coolant path,
wherein the valve is a heat-sensitive valve with a wax or solid expansion element
wherein the valve is installed either on the input side or the output side in the rotor shaft in the region of the at least one transverse bore (7),
wherein the valve is a 3/2-way valve and
wherein the valve is a seat and sliding valve,
wherein a tube seals the valve with respect to a housing of the electric machine or frees a radial coolant path.

2. The electric drive as claimed in claim 1, wherein the valve is arranged in the region of a rotor toothing in the cavity of the rotor shaft.

3. The electric drive as claimed in claim 1, wherein the valve has a restoring spring that restores a valve piston which is displaceable in the valve body.

4. The electric drive as claimed in claim 1, wherein the expansion element is radially arranged between a valve body and a valve piston of the valve.

5. The electric drive as claimed in claim 1, wherein expansion element is a solid element, and the valve opens above a defined temperature of the solid element.

6. The electric drive as claimed in claim 1, wherein a working piston moves axially in and out of the expansion element and opens and closes the valve based on the temperature, wherein the working piston is pressed axially against a valve piston of the valve.

7. The electric drive as claimed in claim 1, wherein the valve has an open position, wherein the tube seals an inflow into the valve with respect to the housing and opens the transverse bore, wherein the valve has a closed position, wherein the valve seals the transverse bore and opens a gap between the housing and the valve.

8. The electric drive as claimed in claim 7, wherein the tube is fixed to a valve piston of the valve.

9. The electric drive as claimed in claim 8, wherein the tube moves with the valve piston based on the temperature of the expansion element.

10. The electric drive as claimed in claim 6, wherein the working piston is in the form of segments of a circle.
